(19) United States
(12) Patent Application Publication
(10) Pub. No.: US 2011/0254296 A1
(43) Pub. Date: Oct. 20, 2011

(54) DOG WASTE SCOOPER CUP AND ASSOCIATED METHOD

(76) Inventor: Monica Chavez, Tucson, AZ (US)

(21) Appl. No.: 13/088,970

(22) Filed: Apr. 18, 2011

Related U.S. Application Data
(60) Provisional application No. 61/324,773, filed on Apr. 16, 2010.

(51) Int. Cl. A01K 29/00

(52) U.S. Cl. 294/1.3

(57) ABSTRACT

A dog waste scooper cup assists a user to pick up dog waste without directly touching the dog waste and preferably includes a body, a handle attached to the body, a curvilinear spout extending upwardly and away from a top-most edge of the body, and a lid pivotally attached to the top-most edge of the body. Notably, the spout may have a serrated top-most end terminating above the top-most edge of the body. Advantageously, the spout may be statically oriented along a direction extending away from the lid such that the spout remains at a stationary position while the lid is pivoted between open and closed positions respectively.

### CROSS REFERENCE TO RELATED APPLICATIONS

This application claims the benefit of U.S. Provisional Application No. 61/324773, filed Apr. 16, 2010, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to pet care products and, more particularly, to a dog waste scooper cup for providing users with a lightweight, lidded, slim cup that allows a dog walker to scoop up their dog's waste without having to directly touch the waste.

2. Prior Art

Many dog owners are burdened by having to scoop up and dispose of their dog's waste. Dog owners are often dissatisfied with using traditional plastic bags as these bags require the dog owners to come into direct physical contact with the waste and then hold onto the waste bag until arriving at a location where they can dispose of it. Other options such as scoop like picker uppers may solve the problem of coming into physical contact with the waste, but they do not secure or contain the waste and its odor.

Accordingly, a need remains for an apparatus in order to overcome the above-noted shortcomings. The present invention satisfies such a need by providing a dog waste scooper cup that is convenient and easy to use, lightweight yet durable in design, versatile in its applications, and designed for providing users with a lightweight, lidded, slim cup that allows a dog walker to scoop up their dog's waste without having to directly touch the waste.

### BRIEF SUMMARY OF THE INVENTION

In view of the foregoing background, it may be therefore an object of the present invention to provide a dog waste scooper cup for assisting a user to pick up dog waste without directly touching the dog waste. These and other objects, features, and advantages of the invention are provided by a dog waste scooper cup including a body, a handle attached to the body, a curvilinear spout extending upwardly and away from a top-most edge of the body, and a lid pivotally attached to the top-most edge of the body. Notably, the spout may have a serrated top-most end terminating above the top-most edge of the body. Advantageously, the spout may be statically oriented along a direction extending away from the lid such that the spout remains at a stationary position while the lid is pivoted between open and closed positions respectively.

In a non-limiting exemplary embodiment, the spout may have a curvilinear bottom-most edge directly and statically connected to a minor circumferential length of the top-most edge.

In a non-limiting exemplary embodiment, the serrated top-most end may be provided with a plurality of coextensively shaped crests and troughs uniformly juxtaposed along an entire longitudinal length of the top-most end.

In a non-limiting exemplary embodiment, the bottom-most end of the spout may have a concave shape provided with a radius equal to a radius of the top-most edge of the body.

In a non-limiting exemplary embodiment, the lid freely pivots about a fulcrum axis located adjacent to the top-most edge of the body and may be further located diametrically opposite from the spout.

In a non-limiting exemplary embodiment, the handle may be entirely located subjacent to the lid and the spout and may have a serrated grip surface facing an outer wall of the body.

In a non-limiting exemplary embodiment, the lid preferably includes a major circumferential edge uniformly extending along a corresponding major circumferential length of the top-most edge of the body. The lid may include a minor circumferential edge spaced inwardly from the minor circumferential length of the top-most edge of the body. In this manner, the major and minor circumferential lengths of the top-most edge are mutually exclusive and non-overlapping.

In a non-limiting exemplary embodiment, the minor circumferential edge of the lid may be equal to an entire circumferential length of the bottom-most edge of the spout.

In a non-limiting exemplary embodiment, the entire circumferential length of the bottom-most edge of the spout directly abuts the minor circumferential edge of the lid when the lid is articulated to the closed position such that dog waste is prohibited from ingressing and egressing the body.

The present disclosure may further include a method of utilizing a dog waste scooper cup for assisting a user to pick up dog waste without directly touching the dog waste. Such a method preferably includes the chronological steps of: providing a body; providing and attaching a handle to the body; providing and extending a curvilinear spout upwardly and away from a top-most edge of the body wherein the spout may have a serrated top-most end terminating above the top-most edge of the body; providing and pivotally attaching a lid to the top-most edge of the body; statically orienting the spout along a direction extending away from the lid; and the spout remaining at a stationary position while pivoting the lid between open and closed positions respectively.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a front perspective view showing a dog waste scooper with the lid articulated to an open position, in accordance with the present invention;

FIG. 2 is a rear perspective view showing the lid at the closed position and abutted against the entire longitudinal length of the spout's bottom-most edge;

FIG. 3 is a front perspective view of the dog waste scooper shown in FIG. 2;

FIG. 4 is a side elevational view of the dog waste scooper shown in FIG. 2;

FIG. 5 is a top plan view of the dog waste scooper shown in FIG. 2; and

FIG. 6 is a rear elevational view of the dog waste scooper shown in FIG. 2.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes or proportions shown in the figures.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “present invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The below disclosed subject matter is to be considered illustrative, and not restrictive, and the appended claims are intended to cover all such modifications, enhancements, and other embodiments which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

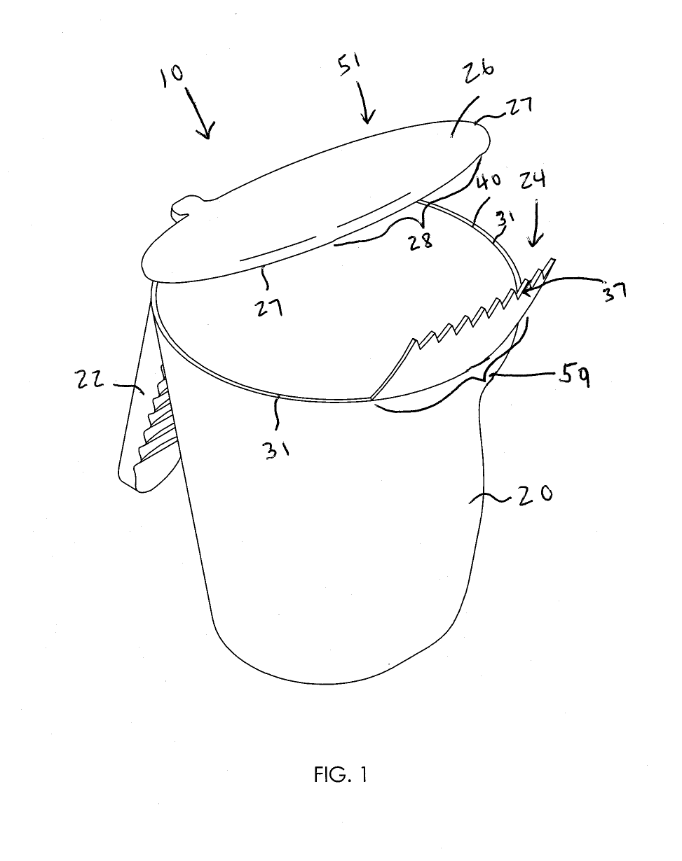

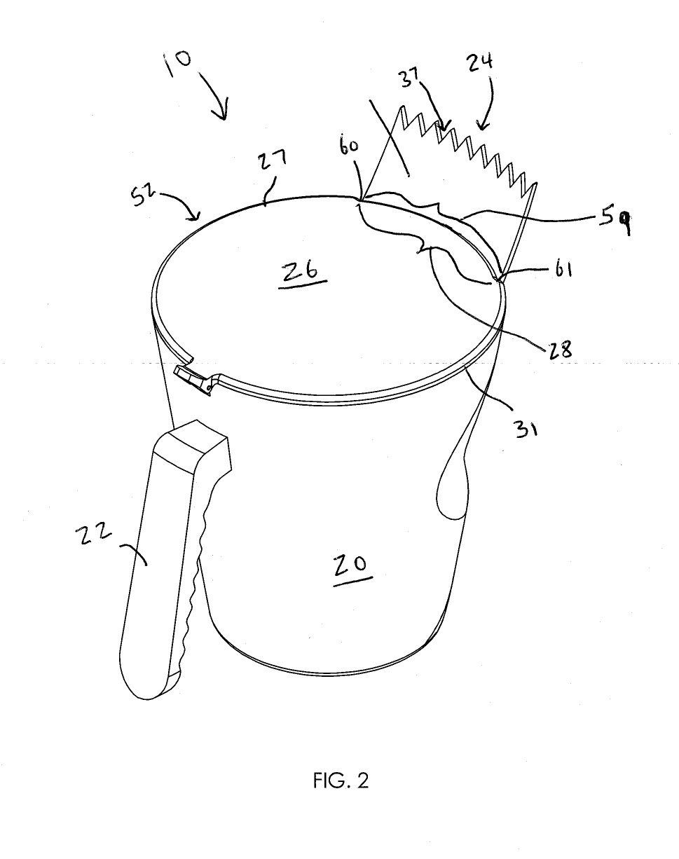

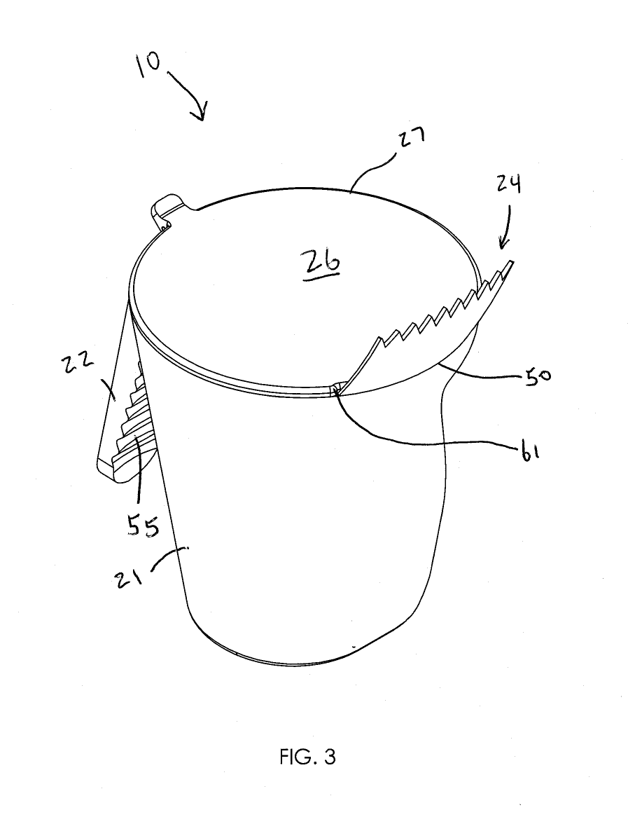

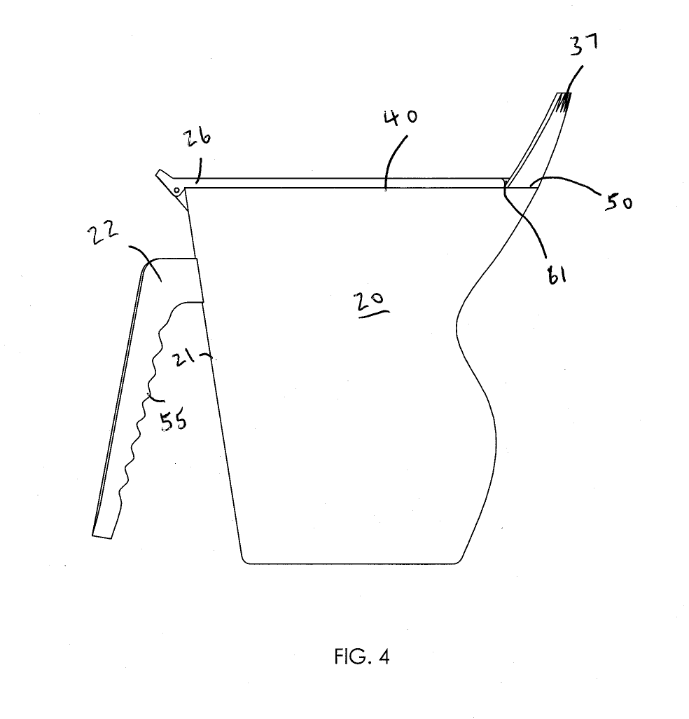

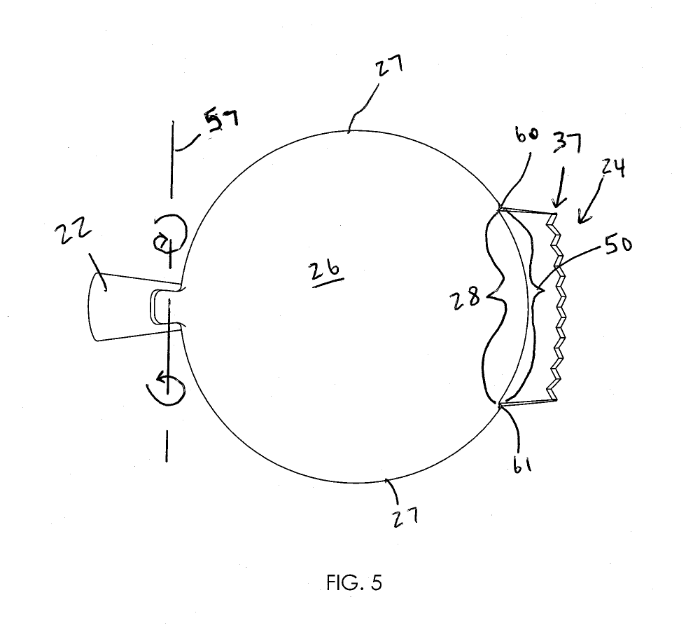

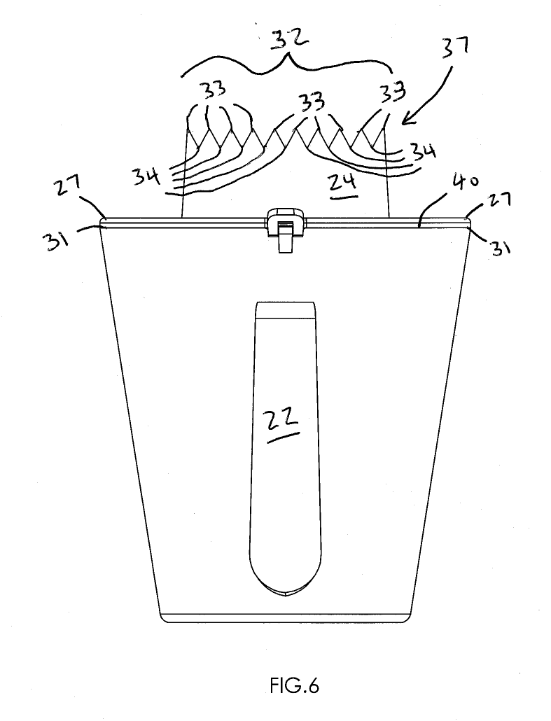

The apparatus of this invention is referred to in FIGS. 1-6 and is intended to provide a dog waste scooper cup 10. It should be understood that the present invention may be used to provide users with a lightweight, lidded, slim cup that allows a dog or other pet walker to scoop up their dog's or other pet's waste without having to directly touch the waste, and should not be limited to the uses described herein.

Referring initially to FIGS. 1-6 in general, a dog waste scooper cup 10 for assisting a user to pick up dog waste without directly touching the dog waste with the user's hand. Such a dog waste scooper cup 10 preferably includes a body 20, a handle 22 attached to the body 20, a curvilinear spout 24 extending upwardly and away from a top-most edge 40 of the body 20, and a lid 26 pivotally attached to the top-most edge 40 of the body 20. Notably, the spout 24 may have a serrated top-most end 37 terminating above the top-most edge 40 of the body 20. Advantageously, the spout 24 may be statically oriented along a direction extending upwardly away from the lid 26 such that the spout 24 remains at a stationary position while the lid 26 is pivoted between open and closed positions 51, 52, respectively. Such a structural configuration provides the unexpected and unpredictable advantage of ensuring the dog waste is easily guided into a trash bag (not shown) located inside the body 20.

In a non-limiting exemplary embodiment, the spout 24 may have a curvilinear bottom-most edge 50 directly and statically connected to a minor circumferential length 28 of the top-most edge 40 of body 20. Such a structural configuration provides the unexpected and unpredictable advantage of ensuring the spout 24 remains diametrically opposed to the fulcrum axis 57 such that dog waste is easily scoop up and deposited into the body 20.

In a non-limiting exemplary embodiment, the serrated top-most end 37 may be provided with a plurality of coextensively shaped crests 33 and troughs 34 uniformly juxtaposed along an entire longitudinal length 32 of the top-most end 37.

In a non-limiting exemplary embodiment, the bottom-most edge 50 of the spout 24 may have a concave shape provided with a radius equal to a radius of the top-most edge 40 of the body 20. Such a structural configuration provides the unexpected and unpredictable advantage of ensuring the spout 24 uniformly extends upwardly from top-most edge 40 and thereby easily guides dog waste into the body 20.

In a non-limiting exemplary embodiment, the lid 26 freely pivots about a fulcrum axis 57 located adjacent to the top-most edge 40 of the body 20 and may be further located diametrically opposite from the spout 24.

In a non-limiting exemplary embodiment, the handle 22 may be entirely located subjacent to the lid 26 and the spout 24 and may have a serrated grip surface 55 facing an outer wall 21 of the body 20.

In a non-limiting exemplary embodiment, the lid 26 preferably includes a major circumferential edge 27 uniformly extending along a corresponding major circumferential length 31 of the top-most edge 40 of the body 20. The lid 26 may include a minor circumferential edge 28 spaced inwardly from the minor circumferential length 59 of the top-most edge 40 of the body 20. In this manner, the major and minor circumferential lengths 31, 59 of the top-most edge 40 are mutually exclusive and non-overlapping. Such a structural configuration provides the unexpected and unpredictable advantage of ensuring the lid 26 prevents dog waste from undesirably egressing out from body 20 during transport.

Notably, the minor circumferential edge 28 of the lid 26 may be equal to an entire circumferential length of the bottom-most edge 50 of the spout 24. Such coextensive edges 28, 50 are defined by a pair of spaced shoulders 60, 61 formed at start and stop points on the minor circumferential edge 28 of the lid 26. The shoulders 60, 61 are stepped inwardly towards a center of the lid 26 and away from spout 24 such that minor circumferential edge 28 of the lid 26 smoothly glides along an interior face 70 of spout 24.

In a non-limiting exemplary embodiment, the entire circumferential length of the bottom-most edge 50 of the spout 24 directly abuts the minor circumferential edge 28 of the lid 26 when the lid 26 is articulated to the closed position 52 such that dog waste is prohibited from ingressing and egressing the body 20.

The present disclosure may further include a method of utilizing a dog waste scooper cup 10 for assisting a user to pick up dog waste without directly touching the dog waste. Such a method preferably includes the chronological steps of: providing a body 20; providing and attaching a handle 22 to the body 20; providing and extending a curvilinear spout 24 upwardly and away from a top-most edge 40 of the body 20 wherein the spout 24 may have a serrated top-most end 37 terminating above the top-most edge 40 of the body 20; providing and pivotally attaching a lid 26 to the top-most edge 40 of the body 20; statically orienting the spout 24 along a direction extending away from the lid 26; and the spout 24 remaining at a stationary position while pivoting the lid 26 between open and closed positions 51, 52, respectively. Such a structural configuration provides the unexpected and unpredictable advantage of ensuring the dog waste is easily guided into a trash bag (not shown) located inside the body 20.

Referring to the figures in general, the dog waste scooper cup 10 may include a light weight plastic, slim body 20 that may preferably have a handle 22 attached to it for the user to hold the dog waste scooper cup 10 in an upright position with. The body 20 base and open top-most edge 40 may be about 3 inches in diameter and 4 inches in height, for example. The spout 24 may feature a jagged edge 37 that travels along a curvilinear path uniformly extending with the top-most edge 40 of body 20. The body 20 may feature a flip top lid 26 which may be pivotally attached to the outer circumference of the body 20 which may be opened and closed by the user's thumb. The body 20 may preferably be fitted with a disposable plastic bag (not shown) to allow the user to easily remove the bag of scooped waste and dispose of it.

In a non-limiting exemplary embodiment, the dog waste scooper cup 10 would be simple and straightforward to use. First, the user may fit a plastic bag inside the body 20 such that the edges of the bag wrap snugly around the circumference of the body 20 top-most edge 40. Next, the user would take his or her dog on a walk or jog as desired while holding onto the dog waste scooper cup by its handle 22. Once the user's dog defecates, the user would lean down, press the flip top lid 26 open with his or her thumb and scoop the waste by inserting the jagged edge 37 underneath the waste and directing it into the body 20 and thereby into the fitted plastic bag. Next, the user would release the flip top lid 26 to closed 52 the body 20 and contain the waste and its odor, without directly touching the waste. Next, the user would complete his or her walk or jog, return home, open the flip top lid 26 with his or her thumb, remove the bag from inside the cup, tie the bag and dispose of it. Next, the user would fit the body 20 with a new plastic bag for future use.

In an alternative embodiment, the cup 10 may feature a locking mechanism on the lid 26 to secure the lid from flapping open while the user is jogging, or a scented plastic bag insert or other scented inserts in order to reduce the odors contained inside the cup 10.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention. In particular, with respect to the above description, it is to be realized that the optimum dimensional relationships for the parts of the present invention may include variations in size, materials, shape, form, function and manner of operation.

What is claimed as new and what is desired to secure by Letters Patent of the United States is:

1. A dog waste scooper cup for assisting a user to pick up dog waste without directly touching the dog waste, said dog waste scooper cup comprising:
a body;
a handle attached to said body;
a curvilinear spout extending upwardly from a top-most edge of said body, said spout having a serrated top-most end terminating above said top-most edge of said body; and
a lid pivotally attached to said top-most edge of said body;
wherein said spout is oriented along a direction extending away from said lid, said spout remaining at a stationary position while said lid is pivoted between open and closed positions respectively.

2. The dog waste scooper cup of claim 1, wherein said spout has a curvilinear bottom-most edge directly and statically connected to a minor circumferential length of said top-most edge.

3. The dog waste scooper cup of claim 1, wherein said serrated top-most end is provided with a plurality of coextensively shaped crests and troughs uniformly juxtaposed along an entire longitudinal length of said top-most end.

4. The dog waste scooper cup of claim 1, wherein said bottom-most end of said spout has a concave shape provided with a radius equal to a radius of said top-most edge of said body.

5. The dog waste scooper cup of claim 1, wherein said lid freely pivots about a fulcrum axis located adjacent to said top-most edge of said body and further located diametrically opposite from said spout.

6. The dog waste scooper cup of claim 1, wherein said handle is entirely located subjacent to said lid and said spout, said handle having a serrated grip surface facing an outer wall of said body.

7. The dog waste scooper cup of claim 2, wherein said lid comprises:
a major circumferential edge uniformly extending along a corresponding major circumferential length of said top-most edge of said body; and
a minor circumferential edge spaced inwardly from said minor circumferential length of said top-most edge of said body;
wherein said major and minor circumferential lengths of said top-most edge are mutually exclusive and non-overlapping;
wherein said minor circumferential edge of said lid is equal to an entire circumferential length of said bottom-most edge of said spout;
wherein said entire circumferential length of said bottom-most edge of said spout directly abuts said minor circumferential edge of said lid when said lid is articulated to said closed position such that dog waste is prohibited from ingressing and egressing said body.

8. A dog waste scooper cup for assisting a user to pick up dog waste without directly touching the dog waste, said dog waste scooper cup comprising:
a body;
a handle attached to said body;
a curvilinear spout extending upwardly and away from a top-most edge of said body, said spout having a serrated top-most end terminating above said top-most edge of said body; and
a lid pivotally attached to said top-most edge of said body;
wherein said spout is statically oriented along a direction extending away from said lid, said spout remaining at a stationary position while said lid is pivoted between open and closed positions respectively.

9. The dog waste scooper cup of claim 8, wherein said spout has a curvilinear bottom-most edge directly and statically connected to a minor circumferential length of said top-most edge.

10. The dog waste scooper cup of claim 8, wherein said serrated top-most end is provided with a plurality of coextensively shaped crests and troughs uniformly juxtaposed along an entire longitudinal length of said top-most end.

11. The dog waste scooper cup of claim 8, wherein said bottom-most end of said spout has a concave shape provided with a radius equal to a radius of said top-most edge of said body.

12. The dog waste scooper cup of claim 8, wherein said lid freely pivots about a fulcrum axis located adjacent to said top-most edge of said body and further located diametrically opposite from said spout.

13. The dog waste scooper cup of claim 8, wherein said handle is entirely located subjacent to said lid and said spout, said handle having a serrated grip surface facing an outer wall of said body.

14. The dog waste scooper cup of claim 9, wherein said lid comprises:
a major circumferential edge uniformly extending along a corresponding major circumferential length of said top-most edge of said body; and
a minor circumferential edge spaced inwardly from said minor circumferential length of said top-most edge of said body;
wherein said major and minor circumferential lengths of said top-most edge are mutually exclusive and non-overlapping;
wherein said minor circumferential edge of said lid is equal to an entire circumferential length of said bottom-most edge of said spout;
wherein said entire circumferential length of said bottom-most edge of said spout directly abuts said minor circumferential edge of said lid when said lid is articulated to said closed position such that dog waste is prohibited from ingressing and egressing said body.

15. A method of utilizing a dog waste scooper cup for assisting a user to pick up dog waste without directly touching the dog waste, said method comprising the chronological steps of:
providing a body;
providing and attaching a handle to said body;
providing and extending a curvilinear spout upwardly and away from a top-most edge of said body, said spout having a serrated top-most end terminating above said top-most edge of said body;
providing and pivotally attaching a lid to said top-most edge of said body;
statically orienting said spout along a direction extending away from said lid; and
said spout remaining at a stationary position while pivoting said lid between open and closed positions respectively.
